(19) United States
(12) Patent Application Publication
(10) Pub. No.: US 2023/0397608 A1
(43) Pub. Date: Dec. 14, 2023

(54) METHOD FOR APPLYING BETA-OCIMENE IN OPEN SPACE

(71) Applicant: Chunlin LIU, Changsha (CN)

(72) Inventors: Chunlin LIU, Changsha (CN); Ying RUAN, Changsha (CN)

(21) Appl. No.: 18/456,064

(22) Filed: Aug. 25, 2023

Related U.S. Application Data
(63) Continuation of application No. PCT/CN2021/131064, filed on Nov. 17, 2021.

(30) Foreign Application Priority Data
Jul. 21, 2021 (CN) 202110826245.X

(51) Int. Cl. A01N 49/00; A01M 9/00; A01N 25/08

(52) U.S. Cl. CPC A01N 49/00; A01M 9/00; A01N 25/08

(57) ABSTRACT

A method for applying beta-ocimene in an open space includes using loose porous material with a particle size of 0.6-10 millimeters as a adsorption carrier, uniformly mixing 1 liter of beta-ocimene with 5-20 kilograms of the carrier to obtain a mixture, and storing and transporting the mixture under a sealed condition; and directly sprinkling the mixture to the plants in the open space by means of uniform sprinkling mode or point-distributed sprinkling mode when in use.

### CROSS-REFERENCE TO RELATED APPLICATIONS

This application is a continuation of PCT/CN2021/131064, filed on Nov. 17, 2021 and claims priority of Chinese Patent Application No. 202110826245.X, filed on Jul. 21, 2021, the entire contents of which are incorporated herein by reference.

### TECHNICAL FIELD

The application relates to the technical field for pest-disease control and prevention, and in particular to a method for applying beta-ocimene in an open space, which enables the beta-ocimene to quickly form an effective induction concentration around plant leaves in the open space on the premise of not damaging plants.

### BACKGROUND

At present, the control and prevention of plant pests and diseases is mainly divided into two types: chemical pesticide control and biological control. Among them, chemical pesticide control and prevention is the most important way to prevent and control pests and diseases. With the deepening of people's understanding of the harm of chemical pesticides, people pay more and more attention to biological control. Biological control is a method of controlling another kind of organisms with one kind organisms, such as insect control by insect, insect control by bird, insect control by bacteria, etc., which has the characteristics of environmental friendliness, but the cost is high and the control effect is greatly affected by external factors, so it is difficult to be applied as widely and conveniently as pesticides.

It is found that beta-ocimene is a volatile monoterpene compound, which is non-toxic and contained in many plants. As a signal molecule of plant communication, beta-ocimene is able to induce plants to develop broad-spectrum resistance to diseases and insect pests. In order to make use of its induced control and prevention effect, it is usually necessary to treat plants in a closed container, and the total volume of beta-ocimene to be added in closed container is calculated according to the final concentration of beta-ocimene and the volume of the container. Because beta-ocimene is an organic volatile substance and spraying beta-ocimene droplets directly on plant leaves will cause damage to plant leaves, in order to avoid this adverse effect, a certain amount of beta-ocimene will be coated on the surface of smooth objects such as glass plates or porcelain plates, so that beta-ocimene will completely volatilize and diffuse to the entire closed space, and finally the required induction concentration of beta-ocimene will be formed in the air of the container, which is able to induce physiological changes of plants and resist the invasion of diseases and pests.

However, this method is only limited in indoor experimental research, because the actual growth conditions of plants such as field, greenhouse, forest, etc. are completely different from the indoor experimental conditions, and it is a fully open space with good air flow. Above method of coating beta-ocimene on the surface of smooth and clean objects to volatilize beta-ocimene naturally has been proved to be infeasible in practice for following reasons: through the research, it is found that firstly, the volatilization speed of beta-ocimene coated on the surface of smooth and clean objects is slow, and the air circulation in open space is fast and unrestricted, which makes it difficult for beta-ocimene to accumulate around plant leaves to form an effective beta-ocimene induction concentration, and then beta-ocimene is not able to induce the plants to resist to pests and diseases; secondly, the actual planting area is usually very vast, so the number of objects to be placed and the workload of coating will also increase with the increase of application area, resulting in huge labor and cost input. At the same time, this operation is difficult to be realized by mechanized coating, and the operation efficiency is also very low. In addition, the remaining of hard objects such as glass plates and porcelain plates will have an adverse impact on the soil, such as the decline of soil permeability and softness.

To sum up, at present, there is no convenient and effective method to induce plant resistance to pests and diseases by using beta-ocimene in open space, which limits the large-scale application of beta-ocimene in agricultural production.

### SUMMARY

The purpose of this application is to provide a method for applying beta-ocimene in an open space, so that beta-ocimene is able to be quickly volatilized in the open space without harming plants, and then an effective induction concentration is able to be formed in the plant canopy in a certain area, and then plants are able to be induced to have an effective defense effect against diseases and insect pests. The technical scheme of the application is as follows.

A method for applying beta-ocimene in an open space takes a loose porous material as a carrier, uniformly mixes beta-ocimene with the carrier to obtain a mixture, stores and transports the mixture in a sealed condition, and directly scatters the mixture to plants in the open space when in use.

In some specific embodiments, the carrier is vermiculite or perlite.

In some specific embodiments, the particle size of the carrier is 0.6-10 millimeters.

In some specific embodiments, the particle size of the carrier is 2-4 millimeters.

In some specific embodiments, 1 liter of beta-ocimene is mixed with 5-20 kilograms of vermiculite or perlite.

In some specific embodiments, the sprinkling area corresponding to the mixture of 1 liter of beta-ocimene and 5-20 kilograms of vermiculite or perlite which are mixed evenly is 1-10 mu (mu, a unit of area, about 666.67 square meters).

In some specific embodiments, the sprinkling mode is uniform sprinkling, and 1-5 kilograms of mixture is evenly sprinkled on plants on one mu of land.

In other specific embodiments, the sprinkling mode is point-distributed sprinkling, and 1-5 sprinkling points are selected on per mu of land, each of sprinkling points has an area of 5-30 square meters, and 0.12-2.1 kilograms of mixture is sprinkled in each of sprinkling points.

Further, for point-distributed sprinkling, in some specific embodiments, one sprinkling point is set in the center of per mu of land, this sprinkling point has an area of 25-30 square meters, and 0.6-2.1 kilograms of mixture is sprinkled in this sprinkling point.

In other specific embodiments, one sprinkling point is set in the center and four corners of per mu of land, respectively, where each of sprinkling points has an area of 5-20 square meters, and 0.12-0.42 kilograms of mixture is sprinkled in each of sprinkling points.

The technical scheme provided by the application has at least the following beneficial effects.

The application uses loose porous materials as the adsorption carrier of beta-ocimene, which is able to significantly increase the surface area and speed up the volatilization of beta-ocimene, rapidly increase the concentration of beta-ocimene in the space around the leaves, and quickly form an effective induction concentration in the plant canopy, thus promoting the plants in the open space to produce effective resistance to diseases and pests. At the same time, because the beta-ocimene is attached to the carrier, the harm to the plant caused by spraying beta-ocimene directly on the surface of the plant is avoided. In addition, both the mixing and stirring process of beta-ocimene and the adsorption carrier and the sprinkling process of the mixture are realized by mechanized operation, and the process is simple and feasible, and the cost is low. Meanwhile, it is convenient to store and transport the mixture of beta-ocimene and loose porous materials, and the loose porous carrier remained in the soil is also beneficial to improving the soil structure.

The method of the application breaks through the technical bottleneck that beta-ocimene is difficult to apply under the existing open space conditions, so that the practical application of using beta-ocimene to improve the resistance of plants to diseases and pests in agricultural production becomes a reality, and the practical application obstacle of beta-ocimene replacing agricultural chemical pesticides is completely removed.

### DETAILED DESCRIPTION OF THE EMBODIMENTS

In order to facilitate understanding of this application, the technical scheme in this application will be described in detail in combination with some preferred embodiments, but the protection scope of this application is not limited to the following specific embodiments. Based on the embodiments in this application, all other embodiments obtained by ordinary technicians in this field without creative work belong to the protection scope of this application.

Unless otherwise defined, all technical terms used hereinafter have the same meaning as commonly understood by those skilled in the field. The technical terms used herein are only for the purpose of describing specific embodiments, and are not intended to limit the protection scope of this application.

A method for applying beta-ocimene in an open space takes a loose porous material as a carrier, uniformly mixes beta-ocimene with the adsorption carrier to obtain a mixture, stores and transports the mixture under a sealed condition, and directly scatters the mixture to plants in an open space (such as forests, fields, etc.) by manpower or unmanned aerial vehicles when in use. In some specific embodiments, the carrier is vermiculite or perlite. Vermiculite and perlite have the characteristics of low price, porosity and large surface area. Using vermiculite or perlite particles to adsorb beta-ocimene is able to significantly increase the volatilization area of beta-ocimene, thus realizing the rapid increase of beta-ocimene concentration in local air and reducing the dilution caused by air flow. In addition, vermiculite and perlite have low density and light weight, which is beneficial to sprinkling, and will not cause harm to plants. After the volatilization of beta-ocimene, the remaining vermiculite and perlite are also used to improve soil quality, thus improving soil hardening and increasing soil permeability.

The average diameter of vermiculite and perlite particles is between 0.6 and 10 millimeters. In some specific embodiments, considering the adsorption effect of beta-ocimene and the convenience of sprinkling, the particle size of the carrier is 2-4 millimeters.

According to the experimental research, when 1 liter of beta-ocimene is mixed with 5-20 kilograms of vermiculite or perlite and the mixture is sprinkled on 1-10 mu of land, crops are induced to have effective resistance to pests and diseases while the economic requirements is satisfied.

In some specific embodiments, the sprinkling mode is uniform sprinkling. In other words, the mixture is evenly sprinkled to plants everywhere. Under this sprinkling mode, the application area of 1 liter of beta-ocimene is 1-5 mu.

In other specific embodiments, the sprinkling mode is point-distributed sprinkling, and the center of per mu of land is set with one sprinkling point, this sprinkling point has an area of 25-30 square meters, and 0.6-2.1 kilograms of mixture is sprinkled in this sprinkling point; or, one sprinkling point is set in the center and four corners of per mu of land, respectively, each of sprinkling points has an area of 5-20 square meters, and 0.12-0.42 kilograms of mixture is sprinkled in each of sprinkling points. Under this sprinkling mode, the application area of 1 liter of beta-ocimene is 5-10 mu. The point-distributed sprinkling is easier to operate, and the dosage is more economical and the cost is lower.

Embodiment 1: After beta-ocimene and vermiculite are mixed, the mixture is sprinkled in wheat field. 1 liter of beta-ocimene and 6 kilograms of vermiculite are taken respectively. While the vermiculite is stirred, beta-ocimene is slowly added to make them fully mixed. 10 mu of land are selected from the wheat field. A mode of setting a single central sprinkling point on per mu is adopted. An area of 25 square meters is taken from the center of each mu and 0.6 kilogram of mixture is sprinkled on this area.

At the same time, 10 mu of plots with the same or similar conditions are selected from the wheat field, and the same amount of vermiculite is added in the same position as the control group.

Compared with the control group, the plants in the wheat field sprinkled with the mixture do not suffer from wheat diseases and pests such as aphids and red spiders.

Embodiment 2: after beta-ocimene is mixed with vermiculite, the mixture is sprinkled in Artemisia annua field.

1 liter of beta-ocimene and 10 kilograms of vermiculite are taken respectively. While the vermiculite is stirred, beta-ocimene is slowly added to make them fully mixed. 2 mu of land are selected from the Artemisia annua field, and 11 kilograms of the mixture is evenly sprinkled on the canopy of Artemisia annua by means of uniform sprinkling.

At the same time, 2 mu of plots with the same or similar conditions are selected from Artemisia annua field, and the same amount of vermiculite is evenly sprinkled in the plots as a control group.

It is found that the plants in the Artemisia annua field sprinkled with the mixture have no disease and pests such as spider mites and aphids, and show obviously better performance than control group.

Embodiment 3: after beta-ocimene and perlite are mixed, the mixture is sprinkled in the greenhouse of paddy field.

1 liter of beta-ocimene and 17 kilograms of perlite are taken respectively. While the perlite stirred, beta-ocimene is slowly added to make them fully mixed. The greenhouse of paddy field with an area of 1 mu adopts point-distributed sprinkling mode. One sprinkling point is set in the center and four corners, respectively, and each of sprinkling points has an area of 5 square meters, and 0.24 kg of mixture is sprinkled in each of sprinkling points.

At the same time, in another greenhouse of paddy field with the same or similar conditions, the same amount of perlite is added at the same position as the control group.

By comparison, it is found that the plants have no rice pests and diseases such as rice planthopper, leaf roller and rice blast in the greenhouse of paddy field where the mixture is sprinkled.

The above is only part of the embodiments of this application, which does not limit the patent protection scope of this application. For those skilled in the field, this application may be modified and varied. Within the spirit and principles of this application, any improvement or equivalent substitution made by using the contents of this application specification, which is directly or indirectly applied to other related technical fields, shall be included in the patent protection scope of this application.

What is claimed is:

1. A method for applying beta-ocimene in an open space, comprising taking a loose porous material as a carrier, uniformly mixing the beta-ocimene with the carrier to obtain a mixture, storing and transporting the mixture in a sealed condition, and directly scattering the mixture to plants in the open space when in use.

2. The method for applying the beta-ocimene in the open space according to claim 1, wherein the carrier is vermiculite or perlite.

3. The method for applying the beta-ocimene in the open space according to claim 2, wherein a particle size of the carrier is 0.6-10 millimeter.

4. The method for applying the beta-ocimene in the open space according to claim 3, wherein the particle size of the carrier is 2-4 millimeters.

5. The method for applying the beta-ocimene in the open space according to claim 3, wherein 1 liter of beta-ocimene is mixed with 5-20 kilograms of vermiculite or perlite.

6. The method for applying the beta-ocimene in the open space according to claim 5, wherein a sprinkling area corresponding to the mixture of 1 liter of beta-ocimene and 5-20 kilograms of vermiculite or perlite is 1-10 mu, wherein the 1 liter of beta-ocimene and 5-20 kilograms of vermiculite or perlite are mixed evenly.

7. The method for applying the beta-ocimene in the open space according to claim 6, wherein a sprinkling mode is uniform sprinkling, and 1-5 kilograms of mixture is evenly sprinkled on plants on one mu of land.

8. The method for applying the beta-ocimene in the open space according to claim 6, wherein a sprinkling mode is point-distributed sprinkling, and 1-5 sprinkling points are selected on per mu of land, each of the sprinkling points has an area of 5-30 square meters, and 0.12-2.1 kilograms of mixture is sprinkled in each of the sprinkling points.

9. The method for applying the beta-ocimene in the open space according to claim 8, wherein one sprinkling point is set in a center of per mu of land, the sprinkling point has an area of 25-30 square meters, and 0.6-2.1 kilograms of mixture is sprinkled in the sprinkling point.

10. The method for applying the beta-ocimene in the open space according to claim 8, wherein one sprinkling point is set in the center and four corners of per mu of land, respectively, wherein each of sprinkling points has an area of 5-20 square meters, and 0.12-0.42 kilograms of mixture is sprinkled in each of sprinkling points.
